(19) United States
(12) Patent Application Publication
(10) Pub. No.: US 2017/0091702 A1
(43) Pub. Date: Mar. 30, 2017

(54) Method and Apparatus to Facilitate a Planned Automated Route Through a Warehouse

(71) Applicant: Wal-Mart Stores, Inc., Bentonville, AR (US)

(72) Inventors: Rick White, Pineville, MO (US); Christopher S. Johnson, Pea Ridge, AR (US); Ricky L. Lewis, Rogers, AR (US); Jimmie R. Clark, Fayetteville, AR (US)

(21) Appl. No.: 15/273,828

(22) Filed: Sep. 23, 2016

Related U.S. Application Data
(60) Provisional application No. 62/233,174, filed on Sep. 25, 2015.

(51) Int. Cl. G06Q 10/08; G06K 19/077; H04B 5/00

(52) U.S. Cl. CPC G06Q 10/087; H04B 5/0056; G06K 19/0776

(57) ABSTRACT

A two-way wireless communications component (such as a near-field communications (NFC) device) is attached to a carton. The two-way wireless communications component has information stored therein regarding, at the least, a planned automated route through a warehouse. By one approach, the automated route information includes information regarding at least one conveyor belt gate in the warehouse. In addition, the two-way wireless communications component can include other information such as a current location of the package in the warehouse, contents that are planned to be placed in the carton, contents that have actually been placed in the carton, a final delivery destination for the carton, and so forth.

### CROSS-REFERENCE TO RELATED APPLICATION

This application claims the benefit of U.S. Provisional Application No. 62/233,174, filed Sep. 25, 2015, and is incorporated herein by reference in its entirety.

### TECHNICAL FIELD

These teachings relate generally to warehouse-based carton packing.

### BACKGROUND

Automated (or partially-automated) warehouse-based carton packing systems are known. Some known systems place optical codes (such as bar codes) on the individual cartons to identify the carton. Though useful, such an approach typically fails to convey one or more useful items of information. Optical codes are also not particularly conducive to updating as the carton makes its way through the warehouse.

Prior art approaches also tend to place considerable reliance upon external resources to gain access to much information regarding the carton. In many cases, for example, the warehouse system reads the optical code and then uses that optical code to access a remote data store to acquire the desired information.

### BRIEF DESCRIPTION OF THE DRAWINGS

The above needs are at least partially met through provision of the method and apparatus to facilitate a planned automated route through a warehouse described in the following detailed description, particularly when studied in conjunction with the drawings, wherein:

FIG. 1 comprises a flow diagram as configured in accordance with various embodiments of these teachings; and

FIG. 2 comprises a schematic representation as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a two-way wireless communications component (such as a near-field communications (NFC) device) is attached to a carton. The two-way wireless communications component has information stored therein regarding, at the least, a planned automated route through a warehouse.

By one approach, these teachings accommodate attaching the two-way wireless communications component to the carton subsequent to forming the carton from a blank. By another approach, if desired, these teachings will accommodate attaching the two-way wireless communications component to a blank from which the carton is formed.

These teachings will also accommodate a variety of planned automated route information. By one approach, for example, the automated route information includes information regarding at least one conveyor belt gate in the warehouse. If desired, these teachings will accommodate leveraging that information to thereby control movement of the carton via such a conveyor belt and actuation/control of such a gate.

In addition to the aforementioned planned automated route information, the two-way wireless communications component can include other information such as a current location of the package in the warehouse, contents that are planned to be placed in the carton, contents that have actually been placed in the carton, a final delivery destination for the carton, and so forth. By one approach, information regarding contents that are actually placed in the carton can be written to the two-way wireless communications component in conjunction with actually placing picked items in the carton.

So configured, a carton can carry information while proceeding through a warehouse that can help ensure the proper and efficient execution of corresponding tasks such as product picking and packing as well as final destination routing. These teachings integrate well with existing approaches and support both automated activity as well as human activity.

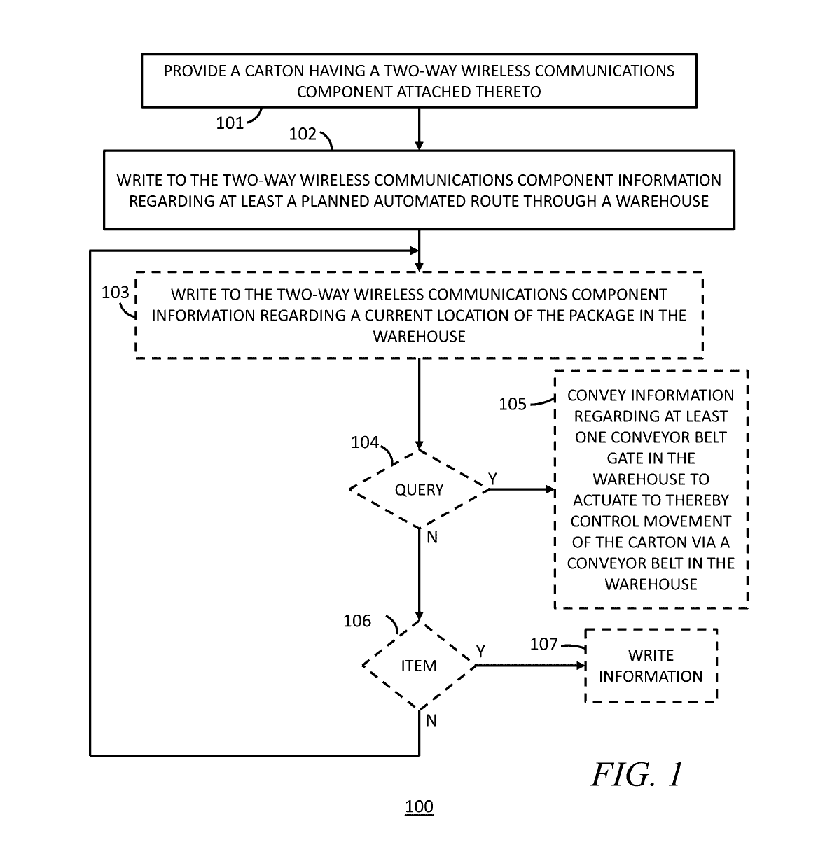

These and other benefits may become clearer upon making a thorough review and study of the following detailed description. Referring now to the drawings, and in particular to FIG. 1, an illustrative process 100 that is compatible with many of these teachings will now be presented.

At block 101 this process 100 provides a carton having a two-way wireless communications component attached thereto. By one approach this can comprise attaching the two-way wireless communications component to the carton subsequent to forming the carton from a blank. By another approach this can comprise attaching the two-way wireless communications component to the blank from which the carton is formed. In either case the two-way wireless communications component can be attached to the carton either prior to arriving at a corresponding warehouse or while at the warehouse.

As used herein the word “carton” will be understood to refer to a container that is configured and intended for use in containing one or more other items (which may themselves have their own corresponding specific, dedicated box or container). Accordingly, a carton is a generic container that is not designed or intended for any one particular specific item.

By one approach the carton is formed of a paperboard material such as corrugated cardboard. Other materials, such as plastic or even wood, are also sometimes employed. In the context of these teachings a carton serves to hold one or more items that are removed from inventory in a warehouse and shipped to a receiving address while contained within such a carton.

The two-way wireless communications component can comprise any of a variety of technology platforms. For the sake of an illustrative example the following description presumes that the two-way wireless communications component comprises a near-field communications (NFC) device. NFC devices are very well known in the art and require no further elaboration here aside from noting that such devices tend to wirelessly communicate with a corresponding reader or writer only over a relatively short distance and that such devices can include a memory that can be read by such a reader and/or written to by such a writer.

It is further presumed in these illustrative examples that the two-way wireless communications component comprises part of a label, such as a paper, paperboard, or plastic label that can be adhered or otherwise attached to the aforementioned carton. These teachings will accommodate including printed material on such a label. That printed material can include illustrations, text, or one or more optical codes (such as a bar code) as desired. The text and/or optical code might represent, for example, a target recipient and/or recipient address as corresponds to the carton.

At block 102 this process 100 provides for writing to the two-way wireless communications component information regarding at least a planned automated route through a warehouse. In particular, this activity can comprise writing such information to the memory of an NFC device. (Those skilled in the art will appreciate that such information can be written to the two-way wireless communications component prior to attaching the two-way wireless communications component to the carton or after attachment.) This information can represent any of a variety of plans, states, and circumstances.

By one approach the information written to the two-way wireless communications component constitutes or otherwise represents a planned automated route through a warehouse. Such a route can represent a complete route through the warehouse or only a portion of that route. Such information can identify, for example, one or more conveyor lines by which the carton can be moved from one location to another within the warehouse. As a related example, such information can identify a particular conveyor path to be selected by an automated conveyor gate (the latter being a well-known conveyor system component in the prior art). As yet a further example, and as illustrated at optional block 104, the foregoing information can include one or more codes or other authorizing instruments or information that can be provided (in response, for example, to a query to the two-way wireless communications component) to system elements such as an automated conveyor gate to cause the latter to pass the carton past the gate or to otherwise control movement of the carton via a conveyor belt or belts in the warehouse.

Other possibilities of course exist in these regards. For example, the aforementioned route information can represent, directly or indirectly, warehouse floors and/or partitioned areas, aisles, columns, shelves, grid coordinates or other indicia of location, elevators, loading docks, doorways, and so forth as desired.

In addition to information regarding a route through a warehouse, other information can be written to the two-way wireless communications component as well (including information that is written to this component at the same time as the route information as well as information that is written to the component prior to the foregoing event or subsequent thereto). Examples in these regards include one, some, or all of information regarding contents planned to be placed in the carton, contents actually placed in the carton, and/or a final delivery destination for the carton. By one approach, and as illustrated at optional block 106, writing information (at block 107) to the two-way wireless communications component regarding contents actually placed in the carton can be undertaken in conjunction with actually placing picked items in the carton.

As another example of information that can be written to the two-way wireless communications component, and as shown at optional block 103, these teachings will accommodate writing to this component information regarding a current location of the carton in the warehouse. By one approach such information can be added to a log of previously-attained locations. By another approach such location information can serve to update previously-written information regarding a previous location of the carton in the warehouse in a way that overwrites the previous information.

So configured the information carried by the carton can serve a variety of useful purposes including facilitating the automated movement of the carton through a potentially complex conveyor system in a warehouse. Those skilled in the art will appreciate that these benefits are achieved without requiring the system elements to continuously refer back to a central store of data but instead can rely upon the local information carried by the carton.

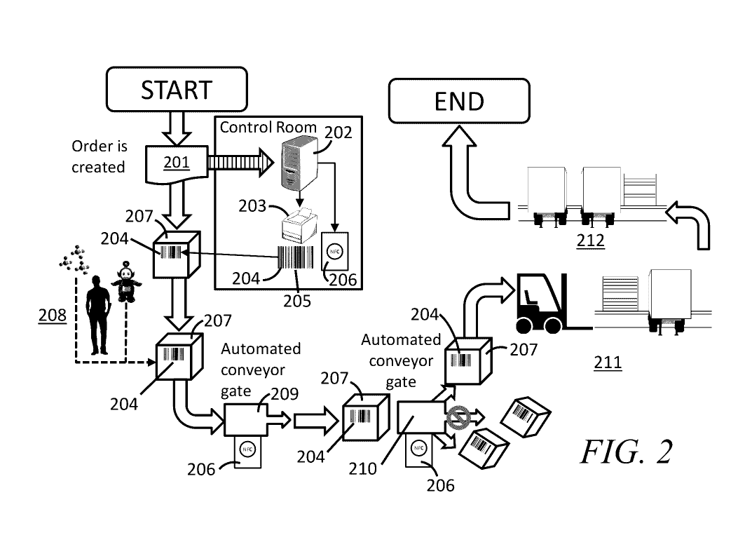

Referring now to FIG. 2, a more specific illustrative example in these regards will be provided. It should be understood that the specifics of the following example are not intended to suggest any particular limitations with respect to these teachings.

The example of FIG. 2 presumes a warehouse having conveyor belts by which cartons can be automatically moved from one place to another. This conveyor belt system includes automated gates that can serve to prevent or allow a carton from moving further through the warehouse and/or that can serve to direct a particular carton to one of a plurality of available conveyor belts. The purpose of this warehouse, at least in part, is to place items in cartons that have been ordered by customers to facilitate delivery of those items to the customers who placed the corresponding orders. Accordingly, a given carton may serve to contain one, two, or more items depending upon a particular customer's order.

The description of this process begins at reference numeral 201 where a particular order is created for a particular recipient. The particulars of this order are utilized by a control circuit 202 of choice to utilize a printer 203 to print an optical code 205 on a corresponding label 204. The control circuit 202 also encodes an NFC device 206 that also comprises a part of the aforementioned label 204.

Being a “circuit,” the control circuit 202 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 202 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 202 is configured (for example, by using corresponding programming as will be well understood by those skilled in the art) to carry out one or more of the steps, actions, and/or functions described herein.

By one approach the control circuit 202 includes a memory that is integral to the control circuit 202. By another approach such a memory can be physically discrete (in whole or in part) from the control circuit 202 as desired. This memory can also be local with respect to the control circuit 202 (where, for example, both share a common circuit board, chassis, power supply, and/or housing) or can be partially or wholly remote with respect to the control circuit 202 (where, for example, the memory is physically located in another facility, metropolitan area, or even country as compared to the control circuit 202).

In addition to the aforementioned information, this memory can serve, for example, to non-transitorily store the computer instructions that, when executed by the control circuit 202, cause the control circuit 202 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

The aforementioned label 204 is then attached to a carton 207, either via an automated process or by a human operator. (It will be understood that other approaches can be accommodated. For example, the label 204 may already be attached to the carton 207 and the control circuit 202 can print the optical code 205 on that label 204 and encode the NFC component 206 in the label 204 per those circumstances.)

In this example the carton 207 then proceeds to an item picking area 208 where one or more human operators pick items that pertain to this particular order and place them in the carton 207. (It will be appreciated that robotic pick-and-place machines could be employed in substitution for one or more such human operators if desired.) Also in this example it is presumed that the human operator activates, directly or indirectly, a writer as each item is placed in the carton 207. This writer responds by writing to the NFC component 206 information regarding each item placed in the carton 207. Accordingly, the NFC component 206 comprises, in these regards, a real-time manifest or log that details the items presently contained in the carton 207. If desired, a timestamp can accompany each such entry and/or information regarding the present location of the carton 207 as such events occur.

As the carton 207 leaves the item picking area 208, the carton reaches a first automated conveyor gate 209. In this example the automated conveyor gate 209 has a reader that reads the contents of the NFC component 206. Also in this example an assessment is made at this time to determine whether the carton 207 is properly packed; that is, that the carton 207 includes all of the items that it should contain and does not contain any items that it should not contain. If errors are found in these regards (based upon an analysis of the contents of the NFC component 206), the system can respond accordingly. By one approach, the automated conveyor gate 209 can redirect the carton 207 to an area where the error can be addressed. By another approach, the automated conveyor gate 209 can be configured to provide an alert to attract the attention of a human operator to thereby bring attention to the erroneous state of the carton 207.

Presuming the carton 207 is properly packed, in this example the carton 207 moves to another automated conveyor gate 210 where again a reader reads the NFC component 206 to determine, for example, a shipping destination for this particular carton 207. The automated conveyor gate 210 can use that information to then direct this carton 207 to a particular conveyor belt that will lead to the appropriate shipping area, staging area, loading dock 211, or the like as per the shipping address or other destination information provided by the NFC component 206.

If desired, upon arriving at the internal destination (such as a particular loading dock 211) the NFC component 206 for the carton 207 can again be read, either automatically or by human operators using, for example, handheld readers, to again check the contents of the carton 207 and/or to ensure that the carton 207 is being loaded on or has been loaded on the correct palette, trailer, vehicle, or the like. Variances in these regards can be reported and appropriate actions taken to resolve the variance.

If desired, readers can also be employed at the shipping destination 212 to reconcile orders with carton contents. Such information can serve to quickly identify variances and prompt curative actions when variances occur.

Accordingly, so configured, a carton deployed with a two-way communications component as described herein can greatly facilitate the efficiency and accuracy of a warehouse carton packing and routing process.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A method comprising:
providing a carton having a two-way wireless communications component attached thereto;
writing to the two-way wireless communications component information regarding at least a planned automated route through a warehouse.

2. The method of claim 1 wherein providing the carton having the two-way wireless communications component attached thereto comprises attaching the two-way wireless communications component to the carton subsequent to forming the carton from a blank.

3. The method of claim 1 wherein the two-way wireless communications component comprises a near-field communications (NFC) device.

4. The method of claim 1 wherein the two-way wireless communications component comprises part of a label and wherein providing the carton having the two-way wireless communications component attached thereto comprises attaching the label to the carton.

5. The method of claim 4 wherein attaching the label to the carton comprises attaching the label to the carton at the warehouse.

6. The method of claim 1 wherein the information regarding at least a planned automated route through the warehouse comprises, at least in part, information regarding at least one conveyor belt gate in the warehouse to actuate to thereby control movement of the carton via a conveyor belt in the warehouse.

7. The method of claim 1 wherein the information further comprises at least one of:
contents planned to be placed in the carton;
contents actually placed in the carton;
a final delivery destination for the carton.

8. The method of claim 7 wherein the information further comprises each of:
contents planned to be placed in the carton;
contents actually placed in the carton;
a final delivery destination for the carton.

9. The method of claim 7 further comprising:
writing to the two-way wireless communications component the information regarding contents actually placed in the carton in conjunction with actually placing picked items in the carton.

10. The method of claim 7 further comprising:
writing to the two-way wireless communications component information regarding a current location of the carton in the warehouse.

11. The method of claim 10 wherein writing to the two-way wireless communications component the information regarding a location of the package in the warehouse comprises writing to the two-way wireless communication component to update previously-written information regarding a previous location of the carton in the warehouse.

12. An apparatus comprising:
a carton;
a two-way wireless communications component that is attached to the carton and having information stored therein regarding at least a planned automated route for the carton through a warehouse.

13. The apparatus of claim 12 wherein the carton is comprised of cardboard.

14. The apparatus of claim 12 wherein the two-way wireless communications component comprises a near-field communications (NFC) device.

15. The apparatus of claim 14 wherein the two-way wireless communications component further comprises a label that includes the NFC device.

16. The apparatus of claim 15 wherein the label includes an adhesive by which the label is attached to the carton.

17. The apparatus of claim 15 wherein the label includes an optical code formed thereon.

18. The apparatus of claim 12 wherein the two-way wireless communications component has further information stored therein regarding at least one of:
contents planned to be placed in the carton at the warehouse;
contents actually placed in the carton at the warehouse;
a final delivery destination for the carton.

19. The apparatus of claim 18 wherein the two-way wireless communications component has further information stored therein regarding each of:
contents planned to be placed in the carton at the warehouse;
contents actually placed in the carton at the warehouse;
a final delivery destination for the carton.

20. The apparatus of claim 18 wherein the two-way wireless communications component has further information stored therein regarding a current location of the carton in the warehouse.
